(19) United States
(12) Patent Application Publication
(10) Pub. No.: US 2019/0303853 A1
(43) Pub. Date: Oct. 3, 2019

(54) SYSTEM AND METHOD FOR SUPPLY CHAIN VERIFICATION USING BLOCKCHAIN

(71) Applicant: Walmart Apollo, LLC, Bentonville, AR (US)

(72) Inventors: Robert CANTRELL, Herndon, VA (US); Daniel W. YOUNG, Rogers, AR (US); John J. O'BRIEN, Farmington, AR (US); Brian MCHALE, Oldham (GB); Todd MATTINGLY, Bentonville, AR (US)

(73) Assignee: Walmart Apollo, LLC, Bentonville, AR (US)

(21) Appl. No.: 16/367,802

(22) Filed: Mar. 28, 2019

Related U.S. Application Data
(60) Provisional application No. 62/649,983, filed on Mar. 29, 2018.

(51) Int. Cl. G06Q 10/08; G06F 16/182; H04L 9/08

(52) U.S. Cl. CPC G06Q 10/0833; G06F 16/1824; H04L 2209/38; H04L 9/0861; H04L 9/0825

(57) ABSTRACT

Systems, methods, and computer-readable storage media for performing a supply chain verification using blockchain. As packages proceed through the supply chain, data associated with each package is uploaded to respective blockchains such that a non-corruptible record can be maintained of how each individual blockchain was processed. This can require gathering current sensor data, comparing it to data previously stored in the blockchain, and if there is a difference, updating the blockchain with a new block. The updated blockchain can then be distributed to databases, other packages/devices, etc., on a distributed ledger.

### PRIORITY

The present application claims priority to U.S. Provisional Patent Application No. 62/649,983, filed Mar. 29, 2018, the contents of which are incorporated herein in their entirety.

### BACKGROUND

### 1. Technical Field

The present disclosure relates to supply chain verification, and more specifically to identifying changes to a package, or how a package is being transported, based on differences between data stored in a blockchain and data detected from sensors.

### 2. Introduction

Blockchain is a shared and distributed ledger that may facilitate the process of recording transactions and tracking assets in a peer-to-peer network. An asset may be tangible (e.g., a house, a car, and so on). An asset may also be intangible like intellectual property (IP), such as patents, copyrights, or branding. For example, a blockchain-based supply chain system may facilitate transferring products and reduce disputes among the parties.

### SUMMARY

An exemplary method which can be performed using concepts disclosed herein can include: receiving, at a processor, a notification that a package is near a sensor having a sensor type; receiving, at the processor from a database, a blockchain record for the package, wherein the processor has access to a private key necessary to amend the blockchain record; identifying, via the processor, most recent data within the blockchain record for the sensor type; comparing, via the processor, the most recent data within the blockchain to current data produced by the sensor, to yield a comparison; identifying, via the processor and based on the comparison, a difference in the most recent data within the blockchain and the current data produced by the sensor; generating, via the processor, a block comprising the difference; adding, via the processor, the block to the blockchain, to yield an updated blockchain; and storing the updated blockchain in the database.

An exemplary system configured according to the concepts disclosed herein can include: a processor; and a computer-readable storage medium having instructions stored which, when executed by the processor, cause the processor to perform operations comprising: receiving a notification that a package is near a sensor having a sensor type; receiving, from a database, a blockchain record for the package, wherein the processor has access to a private key necessary to amend the blockchain record; identifying most recent data within the blockchain record for the sensor type; comparing the most recent data within the blockchain to current data produced by the sensor, to yield a comparison; identifying, based on the comparison, a difference in the most recent data within the blockchain and the current data produced by the sensor; generating a block comprising the difference; adding the block to the blockchain, to yield an updated blockchain; and storing the updated blockchain in the database.

An exemplary non-transitory computer-readable storage medium configured as disclosed herein can have instructions stored which, when executed by a computing device, can cause the computing device to perform operations which include: receiving a notification that a package is near a sensor having a sensor type; receiving, from a database, a blockchain record for the package, wherein the processor has access to a private key necessary to amend the blockchain record; identifying most recent data within the blockchain record for the sensor type; comparing the most recent data within the blockchain to current data produced by the sensor, to yield a comparison; identifying, based on the comparison, a difference in the most recent data within the blockchain and the current data produced by the sensor; generating a block comprising the difference; adding the block to the blockchain, to yield an updated blockchain; and storing the updated blockchain in the database.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example system configuration;

FIG. 2 illustrates exemplary electronics contained within a smart seal;

FIG. 3 illustrates an exemplary blockchain with package data and side chains;

FIG. 4 illustrates an exemplary method claim; and

FIG. 5 illustrates an exemplary computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

When packages are transported, they are subjected to a wide variety of conditions and circumstances which may affect the condition or viability of the package. A record of how the package is transported is often used to confirm inspections, conditions, etc. For example, a package may need to be refrigerated during transport, and a record of the temperature of the carrier (e.g., within the refrigerated truck) may be required by a buyer of that package. Likewise, a record of when a seal has been inspected or verified may be required by the buyer of a package. However, ensuring accuracy of such records can be difficult. Specifically, ensuring that the records are (1) accurate, and (2) unaltered, requires a technical solution such as that disclosed herein. Such accuracy cannot, for example, be accomplished by a human being because human beings can record incorrect values, alter records, or otherwise render the record inaccurate, false, or corruptible.

To counter those detriments, a record of the package is created in a manner which is independent of human influence. As sensors record data about a package, that data is added to a record which is specific to that package. Permission is required to add information to the record, such that unauthorized sensor data is not added. Likewise, once data has been added to the record, removing the data (or altering the data) is difficult, if not impossible. Preferably, this is done through the use of a blockchain using asymmetrical encryption, where private keys are required to add blocks of data to the blockchain for a package. Consider the following example.

A package is sealed at a distribution center and prepared for transit to a retail center. As instructions are received at the distribution center to prepare and ship the package, a blockchain is generated for that package. The blockchain is stored on a distributed ledger which includes a backend database. As the package is sealed or otherwise prepared for transit, sensors record initial data about the package and transmit that initial data to a server. The server adds that initial data (as a new block) to the newly generated blockchain for the package.

As the package is in transit to the retail center, additional sensors can detect the environment of the package, the condition of the package, or other information about the package. For example, a camera, video, or other optical sensor may perform a visual inspection of the package seal and report a quality or condition of the seal back to a central server. Likewise, temperature sensors, vibration sensors, humidity sensors, and other sensor types may report data back to the central server. The central server, upon receiving the data associated with a package, can retrieve the package's blockchain from a database, compare the newly received data to the data stored in the most recent block of the blockchain, and determine if there is a change.

If there is a change between the newly reported data and the stored data, the central server can generate a new block which refers to the previous block, but which contains the new data (or the changes to the previous data). For example, if a first camera checks the seal on the package and determines that the seal has been tampered with, the first camera sensor can send a picture or other sensor data to the central server. The central server can compare that data to data previously saved on the blockchain for that package. If the tampering had been previously identified, no additional data may be saved to the blockchain, whereas if this is the first time the tampering has been identified for that specific package, the blockchain can be modified to include the data.

In addition, the picture or video of the tampered seal may be included as a sidechain to the blockchain. This sidechain can include the data which prompted additions to the blockchain. Examples of the sidechain data can include “raw,” unprocessed sensor data, such as the picture or video of the tampered seal, temperature data, etc. The sidechains can vary from the package specific blockchains in terms of the permissions needed to read the data in a given blockchain, permissions to write to the blockchain, encryption, etc. However, in some configurations, the sidechain, or parts of the sidechain, can be “locked down” when the sidechain contains data which prompted a specific addition of a block to the blockchain.

In some instances, the ability to communicate the sensor data to the central server, or to access a database, may be restricted. For example, the package may be in transit when a temperature sensor in the refrigerated truck detects a temperature spike which needs to be recorded for a package. In some configurations, this can be remedied by the package having a smart seal applied to the package. The smart seal can contain a basic processor, memory, and communications equipment. The smart seal may have power for these computing/communication elements, or the smart seal may be remotely powered (using near field communications, induction, RFID (Radio Frequency Identification), UHF (Ultra High Frequency), etc.). In such configurations, the truck thermometer can register the temperature change, then communicate the data to the package's smart seal. In one example, the smart seal can record the temperature data within the smart seal memory, which can then be communicated to the central server when the package is capable of communicating with a network and the central server. As another example, the smart seal can store a copy of the package's blockchain, compare the sensor data to values stored on the blockchain, and determine if the values are sufficiently different that a new block needs to be generated. If a new block does need to be generated, the package's smart seal can then generate the new block based on the differences between the current sensor data to previous values, then add that block to the stored blockchain within the smart seal. When the package is within range of a network and the central server, the package can communicate the updated blockchain to the central server, where it can replace the stored blockchain for that package with the updated version.

As described, in some configurations, the disclosed systems and methods may be applied to track the physical status of a product, such as temperature, vibration, shock, etc. In some cases, the shipping box/package may include a temperature monitoring device (e.g., a temperature sensor or thermometer). As described above, as long as the temperatures are in compliance with package requirements, no action may be taken. However, once a temperature threshold is crossed, the system or the temperature device can begin logging the over- or under-temperature (and the corresponding time), then add this to the blockchain record. The actual temperature and time data may be recorded in an unencrypted “side-chain,” linked to the blockchain record, but available for inspection without use of a private key. This can allow for identifying trends in the data and comparing carriers or couriers, etc. The system may also compare the “ideal” or “intended” temperatures vs. the actually measured temperatures.

In some configurations, the smart label may be used to record data of time and temperature of a product/package containing the product while the product is in route. The data may be added to the blockchain ledger periodically (i.e., every ten minutes, or other period of time). The smart labels may also be able to track items/products and identify products which have been exposed to temperatures outside of their requirements. This information can then be used to recall certain products.

In some configurations, the smart label may communicate with the point of sale (POS) and self-checkout system (SCO) devices to indicate that the product is temperature compliant at the sale point. Similarly, the smart label (or seal) may communicate with refrigerators, scales, humidity sensors, etc., which can detect information about the package and otherwise provide information about the status of the product.

In some configurations, a smart seal, or label, may be affixed to the case/box/package of products at the manufacturer. The smart seal may track the time and temperature exposure of the case until it is unpacked. Once unpacked, the smart seal can communicate with the individual product seals and download the time/temperature data to those individual smart seals. That is, the smart seal for the case can then communicate the data to the individual smart seals for the individual products stored in the case.

In some configurations, if a peer-to-peer network is permissioned, it can enable the creation of a parties-only network with proof that parties are who they say they are and that background documents are exactly as represented. This may further protect the system against tampering, fraud, and/or cybercrime.

In some configurations, through the use of IDs, private keys, and permissions, parties can specify which sensor details they want other parties/participants to be permitted to view. Permissions can be expanded or limited on an individual or group basis. For example, some groups may be limited as to what aspects of sensor data, stored in a blockchain or other secure format, they may see. However, some individuals within that group may be less restricted than the overall group.

In some configurations, permissions and cryptography may be used to prevent unauthorized access to the database and blockchains, and thereby ensure (1) that parties/participants are who they claim to be and (2) that only authorized parties are looking at, or modifying, the package records. Privacy can be maintained through cryptographic techniques (such as asymmetric cryptography) and/or data partitioning techniques to give parties/participants selective visibility into the ledger. In some configurations, the identity of parties making additions or modifications to the blockchain can be masked.

In some configurations, the package data can be recorded in a fob, smart seal, RFID, or other device which is associated with the package. Such devices can have memory, a processing unit, the ability to communicate with the Internet, the ability to communicate with other packages or Internet of Things (IOT) devices, etc. In some cases, the memory device can include a destination address (such as a residential address for a package being delivered, or a retail store number for a package in transit between a distribution center and a retail store). The destination address can, however, be modified as necessary by the system, thereby enabling smart package routing while simultaneously maintaining a complete and accurate record of where the package has gone, and to what conditions the package has been exposed. The destination address, recipient and other delivery information may be stored or coded in the blockchain for the package. This makes it difficult to re-route the package. Nay entity with access to the blockchain can determine if the package is being properly routed, or if it has been improperly re-routed.

In some cases, the sensor data received can be close to previous values, but not exactly identical. In such cases, the processor can compare the stored data to the current sensor data and determine if the current sensor data is outside of a predefined range, or threshold range. If so, the processor can initiate the generation of a new block to the added to the blockchain, whereas if the sensor data is different, but within the threshold range, the processor may ignore the identified change.

As described above, preferably, the determination regarding whether to generate a new block and add that block to the blockchain is made either by the processor co-located with the package as part of a smart seal/label, or by a central computing system, such as a server. However, in some cases the computing can be allocated out to other processors which have greater access to power or processing capacity. For example, if a package is being transported in a truck, the truck may have a separate computing system which can read the blockchain information associated with a package, receive the sensor data, and make the updates to the blockchain. In another example, the package may make the initial determination that a block needs to be generated, then transmit a request to the truck to generate the block. Likewise, distribution of computing can be done with other nearby packages or IOT devices.

The disclosure now turns to the exemplary configurations depicted in the Figures. The features and steps outlined herein are exemplary and can be implemented in any combination thereof, including combinations that exclude, add, or modify certain features or steps.

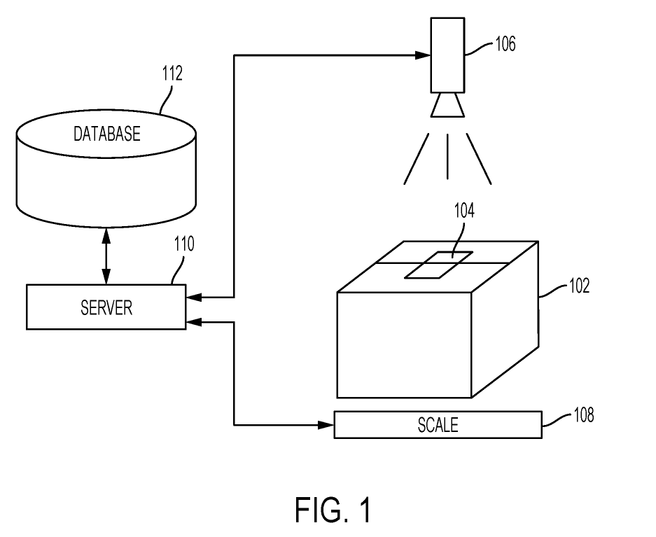

FIG. 1 illustrates an example system configuration. In this example, a package 102 has a smart seal 104 applied to the package 102. The smart seal 104 can be photographed by a camera (or other optical sensor) 106 to verify that the smart seal 104 is intact. The photographic data can be communicated from the camera 106 to a server 110, which can analyze the photographic data. Specifically, the server 110 has access to data stored in a database 112, where the database 112 contains information about the package 102. When the server 110 receives data about the package 102 (or the seal 104) from the camera 106 which is sufficiently different than the previously stored data, the server 110 can update the package-specific data stored in the database 112. In some configurations, this update can include generating a new block of data, then adding the new block to the blockchain. This new block can be an entirety of the current sensor data, or can be just the changes (delta values) over the previously stored data associated with that package.

In some configurations, the optical sensor/camera 106 can provide data regarding the condition of a seal 104. For example, the seal 104 may, when first applied, be considered perfect, a “10”, and later the camera 106 may detect a small tear in the seal 104, such that the seal is compromised—a “6”. The system can then update the database 112 with the new seal condition “6”, or the change (“−4”).

Another exemplary sensor is a scale 108 which can detect information about the weight of the package 102. If the scale 108 reports data to the server 110 which is different than previously stored data about the package 102, the server 110 can similarly update the package-specific data. Other exemplary sensors can include vibration sensors, shock sensors, temperature sensors, humidity sensors, infrared sensors, etc.

In some configurations, the seal 104 can store data (either a portion or a complete copy) of the data stored in the database 112. For example, the database 112 can store a blockchain specific to the package 102, and the seal 104 can have memory which stores either a copy of the blockchain, or a copy of a portion of the blockchain. If the sensors 106, 108 are unable to communicate with the server 110, the sensors 106, 108 may wirelessly communicate with the smart seal 104 to store the sensor data or differences within the smart seal 104 memory. This distributed ledger can then be propagated to the server 110 when the package 102 is within network range.

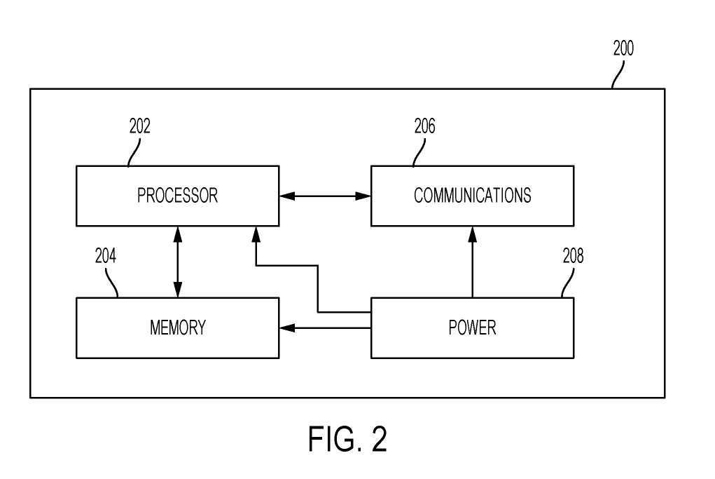

FIG. 2 illustrates exemplary electronics contained within a smart seal 200. In this example, the smart seal 200 contains a processor 202, memory (such as RAM (Random Access Memory) or ROM (Read Only Memory) 204, communications equipment 206, and a power source 208. In a first example, the communications equipment 206 can receive sensor data from sensors evaluating a current condition of a package associated with the seal 200. The processor 202 can receive that sensor data from the communications equipment 206, then compare that data to data retrieved from the memory 204. If the processor 202 detects a difference, or delta, between the current sensor data and the previously stored data, the processor 202 can update the data stored in the memory 204, or can add a new block to a blockchain stored in the memory 204.

The communications equipment 206 can include one or more antennas, amplifiers, etc., configured to transmit and/or receive data from outside (non-contiguous) resources. The power 208 can be a battery, or can be a mechanism to receive power through outside mechanisms, such as induction, RF power, UHF power, or other near-field power mechanisms.

In addition, the smart seal 200 may communicate via WIFI with blockchain, for example, to receive the supply chain requirements for the products and/or send the processed sensory data to the blockchain. Also the smart seal 200 may be configured to activate and/or deactivate some sensors based on the requirements for each product, package or case. For example, if all items in the package or case are temperature-controlled, then no vibration sensors are required, so the vibration sensors can be deactivated. The smart seal 200 may be activated when items are loaded into the package or case. The activation signal may include instruction to obtain the logic for the mission from a blockchain location. The logic may be loaded into and run by the smart seal 200. The logic may define the sensors to be activated, the parameters to be monitored, threshold levels or ranges. The logic may also provide the smart seal a ledger location to use in storing information associated with the present mission.

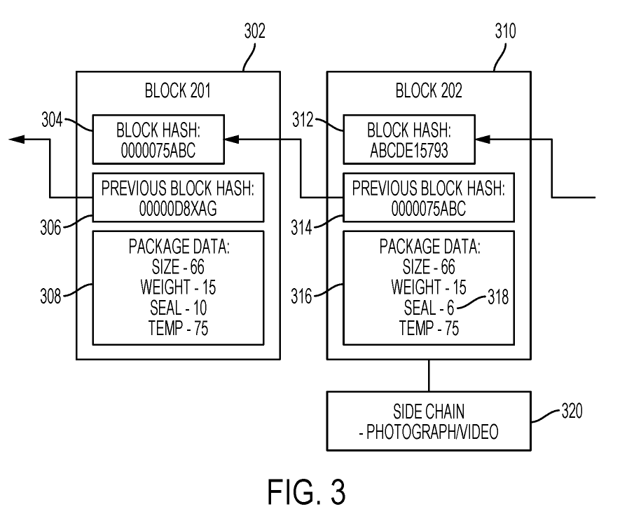

FIG. 3 illustrates an exemplary blockchain with package data 308, 316, and side chains 320. In this example, there are two blocks 302, 310. Within each block 302, 310 are a block hash 304, 312, a reference to the previous block's hash 306, 314, as well as package data 308, 316. The block hash 304, 312 is the output of a hash function, where the inputs to the hash function include the package data 308, 316 and the previous hash 306, 314. If there is a block number, or other identification, that information can likewise be included as an input to the hash function. The previous block hash 306, 314 refers to the hash function output of the previous block, such that the previous block hash 314 of the second block 310 refers to the block hash 304 of the previous block 302.

When changes to the package data 308, 316 are detected, a new block can be generated and added to the blockchain, with updated package data 308, 316 (or the detected differences). In the illustrated example, the condition of a seal has changed from “10” in the first package data 308, to a “6” 318 in the second package data 316. In addition, the cause for a new block being added to the blockchain can be added as a sidechain 320. In this case, the cause is a photograph, or a video, of the seal, whereas in other cases it may be raw sensor data, processed sensor data, etc. In some configurations, the sidechain 320 can be subject to the same encryption as the remainder of the blockchain, whereas in other configurations the sidechain 320 may be publically available (i.e., not subject to encryption).

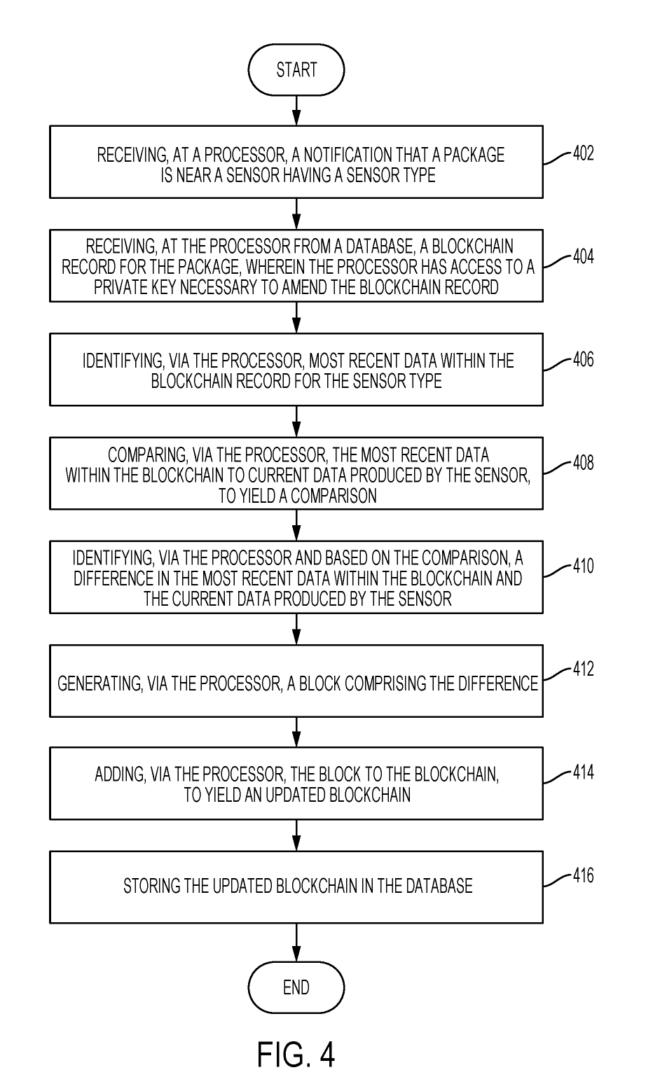

FIG. 4 illustrates an exemplary method claim. In this example, a system is configured to receive, at a processor, a notification that a package is near a sensor having a sensor type (402). The system receives, at the processor from a database, a blockchain record for the package, wherein the processor has access to a private key necessary to amend the blockchain record (404) and identifies, via the processor, most recent data within the blockchain record for the sensor type (406). The system compares, via the processor, the most recent data within the blockchain to current data produced by the sensor, to yield a comparison (408), and identifies, via the processor and based on the comparison, a difference in the most recent data within the blockchain and the current data produced by the sensor (410). The system generates, via the processor, a block comprising the difference (412) and adds, via the processor, the block to the blockchain, to yield an updated blockchain (414). The system then stores the updated blockchain in the database (416).

In some configurations, both the processor and the database can be part of a smart seal attached to the package. In such configurations, the method can further include identifying the package as within a communications range of a network; and transmitting the updated blockchain from the database to the network.

In some configurations, the processor and the database can be part of a non-mobile computing system.

Exemplary sensors can include one or more of a scale, a thermometer, a camera, a humidity sensor, an accelerometer, a light sensor, and GPS (Global Positioning System) receiver. In some configurations, the difference must be above a threshold to be considered, and that threshold can vary according to a package type and the sensor type. For example, humidity may matter less for a refrigerated package versus an electronics package, and so the threshold range for requiring a modification due to a change in humidity for a refrigerated package may be larger than a similar range for an electronics package. Similar variations in food packages, clothing packages, outdoor packages, etc., may result in a wide variety of thresholds and ranges.

In some configurations, the method can further include storing the current data in a non-encrypted side chain associated with the blockchain.

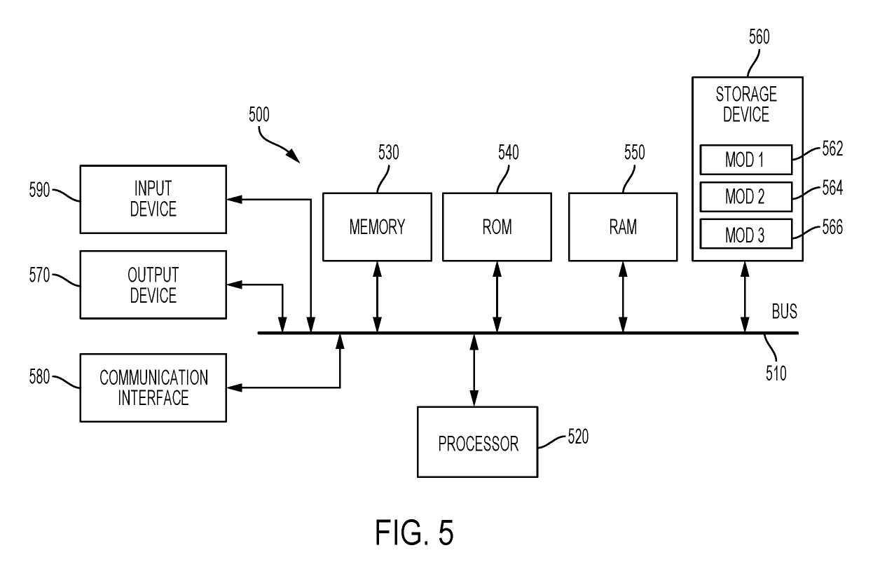

With reference to FIG. 5, an exemplary system includes a general-purpose computing device 500, including a processing unit (CPU or processor) 520 and a system bus 510 that couples various system components including the system memory 530 such as read-only memory (ROM) 540 and random access memory (RAM) 550 to the processor 520. The system 500 can include a cache of high-speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a processor, a notification that a package is near a sensor having a sensor type;
receiving, at the processor from a database, a blockchain record for the package, wherein the processor has access to a private key necessary to amend the blockchain record;
identifying, via the processor, most recent data within the blockchain record for the sensor type;
comparing, via the processor, the most recent data within the blockchain to current data produced by the sensor, to yield a comparison;
identifying, via the processor and based on the comparison, a difference in the most recent data within the blockchain and the current data produced by the sensor;
generating, via the processor, a block comprising the difference;
adding, via the processor, the block to the blockchain, to yield an updated blockchain; and
storing the updated blockchain in the database.

2. The method of claim 1, wherein the processor and the database are part of a smart seal attached to the package.

3. The method of claim 2, further comprising:
identifying the package as within a communications range of a network; and
transmitting the updated blockchain from the database to the network.

4. The method of claim 1, wherein the processor and the database are part of a non-mobile computing system.

5. The method of claim 1, wherein the sensor is at least one of a scale, a thermometer, a camera, a humidity sensor, an accelerometer, a light sensor, and GPS (Global Positioning System) receiver.

6. The method of claim 1, wherein the difference is above a threshold, and wherein the threshold varies according to a package type and the sensor type.

7. The method of claim 1, further comprising storing the current data in a non-encrypted side chain associated with the blockchain.

8. A system comprising:
a processor; and
a computer-readable storage medium having instructions stored which, when executed by the processor, cause the processor to perform operations comprising:
receiving a notification that a package is near a sensor having a sensor type;
receiving, from a database, a blockchain record for the package, wherein the processor has access to a private key necessary to amend the blockchain record;
identifying most recent data within the blockchain record for the sensor type;
comparing the most recent data within the blockchain to current data produced by the sensor, to yield a comparison;
identifying, based on the comparison, a difference in the most recent data within the blockchain and the current data produced by the sensor;
generating a block comprising the difference;
adding the block to the blockchain, to yield an updated blockchain; and
storing the updated blockchain in the database.

9. The system of claim 8, wherein the system is part of a smart seal attached to the package.

10. The system of claim 9, the computer-readable storage medium having instructions stored which, when executed by the processor, cause the processor to perform operations comprising:
identifying the package as within a communications range of a network; and
transmitting the updated blockchain from the database to the network.

11. The system of claim 8, wherein the system is part of a non-mobile computing system.

12. The system of claim 8, wherein the sensor is at least one of a scale, a thermometer, a camera, a humidity sensor, an accelerometer, a light sensor, and GPS (Global Positioning System) receiver.

13. The system of claim 8, wherein the difference is above a threshold, and wherein the threshold varies according to a package type and the sensor type.

14. The system of claim 8, the computer-readable storage medium having instructions stored which, when executed by the processor, cause the processor to perform operations comprising storing the current data in a non-encrypted side chain associated with the blockchain.

15. A non-transitory computer-readable storage device having instructions stored which, when executed by a computing device, cause the computing device to perform operations comprising:
receiving a notification that a package is near a sensor having a sensor type;
receiving, from a database, a blockchain record for the package, wherein the processor has access to a private key necessary to amend the blockchain record;
identifying most recent data within the blockchain record for the sensor type;
comparing the most recent data within the blockchain to current data produced by the sensor, to yield a comparison;
identifying, based on the comparison, a difference in the most recent data within the blockchain and the current data produced by the sensor;
generating a block comprising the difference;
adding the block to the blockchain, to yield an updated blockchain; and
storing the updated blockchain in the database.

16. The non-transitory computer-readable storage device of claim 15, wherein the computing device is part of a smart seal attached to the package.

17. The non-transitory computer-readable storage device of claim 16, having instructions stored which, when executed by the computing device, cause the computing device to perform operations comprising:
identifying the package as within a communications range of a network; and
transmitting the updated blockchain from the database to the network.

18. The non-transitory computer-readable storage device of claim 15, wherein the computing device is part of a non-mobile computing system.

19. The non-transitory computer-readable storage device of claim 8, wherein the sensor is at least one of a scale, a thermometer, a camera, a humidity sensor, an accelerometer, a light sensor, and GPS (Global Positioning System) receiver.

20. The non-transitory computer-readable storage device of claim 8, wherein the difference is above a threshold, and wherein the threshold varies according to a package type and the sensor type.
